(19) United States
(12) Patent Application Publication
(10) Pub. No.: US 2003/0182146 A1
(43) Pub. Date: Sep. 25, 2003

(54) Method, device, and program for managing license of ASIC development tool

(75) Inventors: Hitoshi Watanabe, Kawasaki (JP); Yoshiaki Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/334,013

(22) Filed: Dec. 31, 2002

(30) Foreign Application Priority Data
Mar. 20, 2002 (JP) 2002-078441

(51) Int. Cl. G06F 17/60

(52) U.S. Cl. 705/1

(57) ABSTRACT

A license contract of ASIC development tool is completed between an ASIC vendor and a tool vendor, and then the ASIC vendor makes a sublicense contract of the tool with a customer who intends to develop an ASIC. Information including a customer name, a development tool name, a lease condition of the development tool, a request for license key lease is transmitted from the customer computer 11 to the ASIC vendor computer 10. Receiving the information, the ASIC vendor computer 10 transmits to the tool vendor computer 12 information of requesting the license key lease if it is determined that the predetermined condition of license key lease is satisfied. In response to the receipt of the information, the tool vendor computer 12 transmits a license key through the ASIC vendor computer 10 to the customer computer 11.

### CROSS-REFERENCE TO RELATED APPLICATIONS

This application is based upon and claims the benefit of priority from the prior Japanese Patent Application No. 2002-078441, filed on Mar. 20, 2002, the entire contents of which are incorporated herein by reference.

### BACKGROUND OF THE INVENTION

1. Field of the Invention

The present invention relates generally to a method, device, and program for managing a license of an ASIC (Application-Specific Integrated Circuit) development tool, and more particularly to a method, device, and program wherein an ASIC vendor mediates between a tool vender and its customers who are also ASIC vendor's customers.

2. Description of the Related Art

In a case where a customer of an ASIC vendor develops an integrated circuit, in the prior art, the customer purchases a development tool recommended by the ASIC vendor.

However, since the development tool is generally expensive, the customer keeps a distance away from it, even if it is an effective tool, so that the ASIC vendor and the tool vendor have lost their business chance.

### SUMMARY OF THE INVENTION

Accordingly, it is an object of the present invention to provide a method, device, and program for managing a license of an ASIC development tool, which promotes the distribution of ASIC development tool to increase the benefits of an ASIC vendor, a tool vendor, and their customers.

In one aspect of the present invention, there is provided a license management method wherein an ASIC vendor computer, a tool vendor computer, and a customer computer are interconnected through a network.

A license contract of ASIC development tool is completed between an ASIC vendor and a tool vendor, and then the ASIC vendor makes a sublicense contract of tool with a customer who intends to develop an ASIC. Then, the following processes are performed:

(a) The customer computer transmits first information to the ASIC vendor computer, the first information including a customer name, a development tool name, a lease condition of the development tool, and a request for a license key lease.

(b) In response to reception of the first information, the ASIC vendor computer checks whether the first information satisfies a predetermined condition of the license key lease, and transmits to the tool vendor computer second information of requesting for the license key lease if it is determined the predetermined condition is satisfied.

(c) In response to reception of the second information, the tool vendor computer issues a license key for the customer.

This license management method allows promoting the distribution of the ASIC development tool, thereby increasing the benefits of the ASIC vendor, the tool vendor, and their customers.

Other aspects, objects, and the advantages of the present invention will become apparent from the following detailed description taken in connection with the accompanying drawings.

### BRIEF DESCRIPTION OF THE DRAWINGS

FIG. 1 is a schematic diagram showing a network system for carrying out a license management method according to one embodiment of the present invention.

FIG. 2 is a schematic diagram showing the flow of information on the network when mass production begins.

FIG. 3 is an illustration of an embodiment of a table included in the license management database 14 of FIG. 1.

FIGS. 4(A) and 4(B) are illustrations of an embodiment of tables included in the accounting database 16 of FIG. 1.

FIG. 5 is a flowchart showing the procedure and information process of license key lease.

FIG. 6 is a flowchart continued from FIG. 5.

FIG. 7 is a flowchart showing the procedure and information process of mass production start up in relation to product fee.

FIG. 8 is an illustration of an example of an inputting form on the screen of an ASIC vendor computer, for requesting a license key lease, which is used in step S3 of FIG. 5.

### DESCRIPTION OF THE PREFERRED EMBODIMENT

Referring now to the drawings, wherein like reference characters designate like or corresponding parts throughout several views, a preferred embodiment of the present invention are described below.

Initially, a license contract of an ASIC development tool is made between an ASIC vendor and a tool vendor. This contract includes a tool name; the number of license key leases; a permission to establish a sublicense; a lump-sum payment of license fee to the tool vendor by the ASIC vendor at a time when the contract is made; and a payment of product fee per mass-produced chip or per product kind, where the product fee arises when the ASIC vendor starts mass production of the integrated circuit after the integrated circuit development is succeeded.

This contract removes the need for the tool vendor to conduct sales activities toward the tool's consumers, and also allows the tool vendor to invest the license fee, which have been obtained in lump sum at an early date, in the tool's improvement or a new tool development.

Next, the ASIC vendor makes a sublicense contract with a customer who intends to develop an ASIC. This contract is a basic one made before a detailed contract, and includes a tool name, the number of license key leases, a unit price of license key lease, a unit price of product fee, and time and method for payments of the license key lease fee and the product fee.

As the number of the sublicense's contractors increases, both the license key lease fee and the number of mass production requests increases. Therefore, the ASIC vendor willingly makes an effort to secure a larger number of customers, making it possible to set the license key lease fee at a lower price. As the ASIC vendor sets unit price of license key lease at a lower price, the number of license key contracts increases, accordingly the number of product kinds increases. This increase allows a lot of product fees to be given to the tool vendor.

Since the ASIC vendor is accurately aware of information on mass production, the ASIC vendor's management of the product fee allows the tool vendor to surely acquire the product fee.

Such a secure license management permits the tool vendor to increase its own benefit than was previously possible. In addition, the customer can get the tool by paying the license key lease fee set at a low price by paying the product fee in future. This allows the customer to reduce the early-stage development cost, and therefore the number of the tool users increases. Because the number of ASIC developments increases due to the increase of the number of the tool users, the ASIC vendor can raise its own profit, as well as make an additional profit by mediating the license establishment.

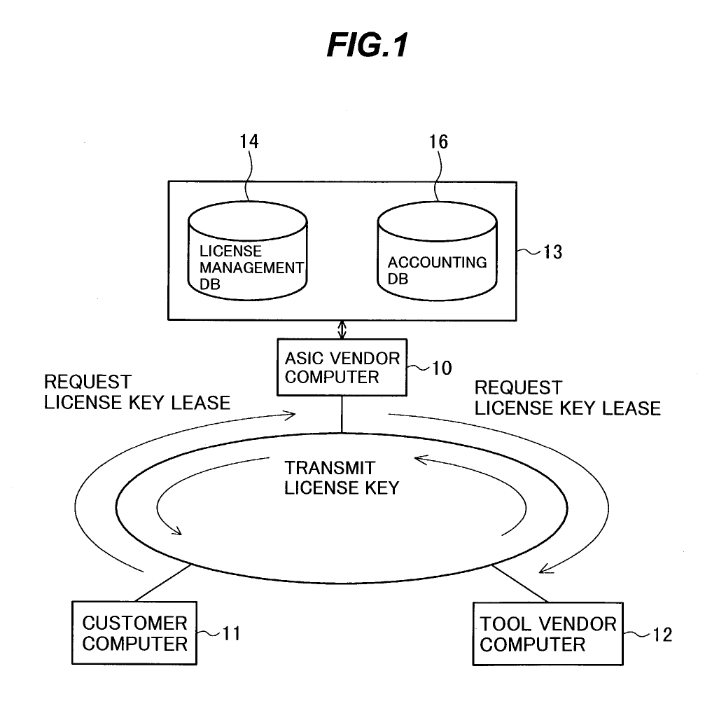

FIG. 1 is a schematic diagram showing a network system for carrying out a license management method according to one embodiment of the present invention.

An ASIC vendor computer 10, a customer computer 11, and a tool vendor computer 12 are interconnected through a network. A storage device 13 is connected to the ASIC vendor computer 10 to store a license management database 14 and an accounting database 16. Data on sublicense contracts are stored in these databases.

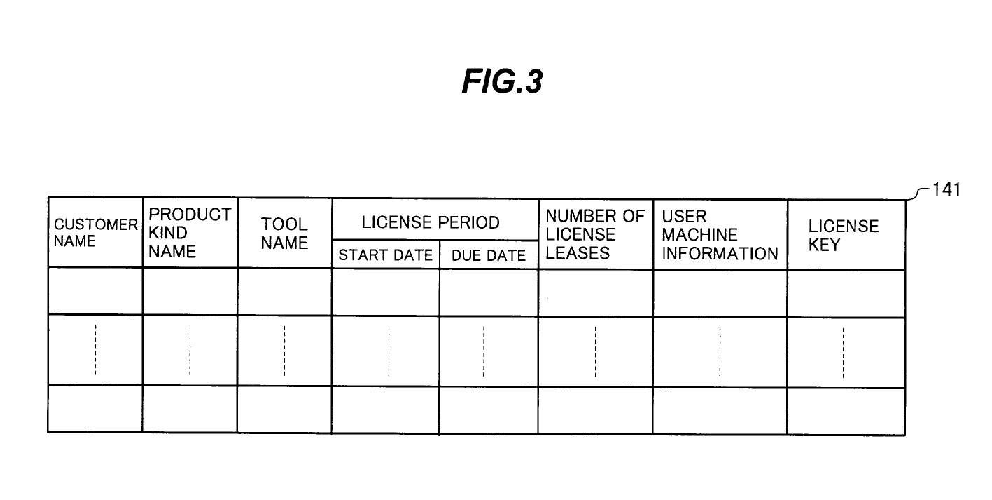

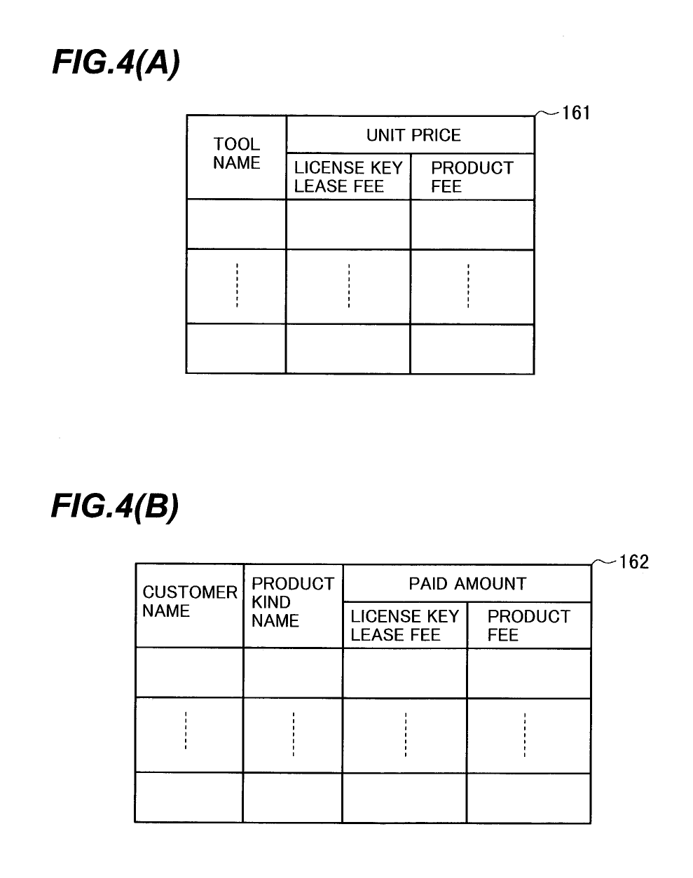

FIG. 3 is an illustration of the configuration of a table 141 included in the license management database 14 of FIG. 1. This table includes fields of customer name, product kind name, tool name, license period, number of license key leases, customer machine information, and license key code. FIGS. 4(A) and 4(B) are illustrations of the configurations of tables 161 and 162, respectively, included in the accounting database 16 of FIG. 1. The table 161 includes fields of tool name, unit price of license key lease, and unit price of product fee. The table 162 includes fields of customer name, product kind name, paid amount of license key lease fee, and paid amount of product fee.

Referring back to FIG. 1, information to be mentioned below is provided to the ASIC vendor computer 10 from the customer computer 11 so as to request a license key lease. In response to this request, the ASIC vendor computer 10 calculates the license key lease fee with reference to the license management database 14 and the accounting database 16. If the customer has paid the calculated lease fee to the ASIC vendor, the ASIC vendor computer 10 requests the tool vendor computer 12 for a license key lease. In response to this request, the tool vendor computer 12 transmits the license key through the ASIC vendor computer 10 to the customer computer 11. Such a procedure allows the tool vendor to know distribution status of its own tool.

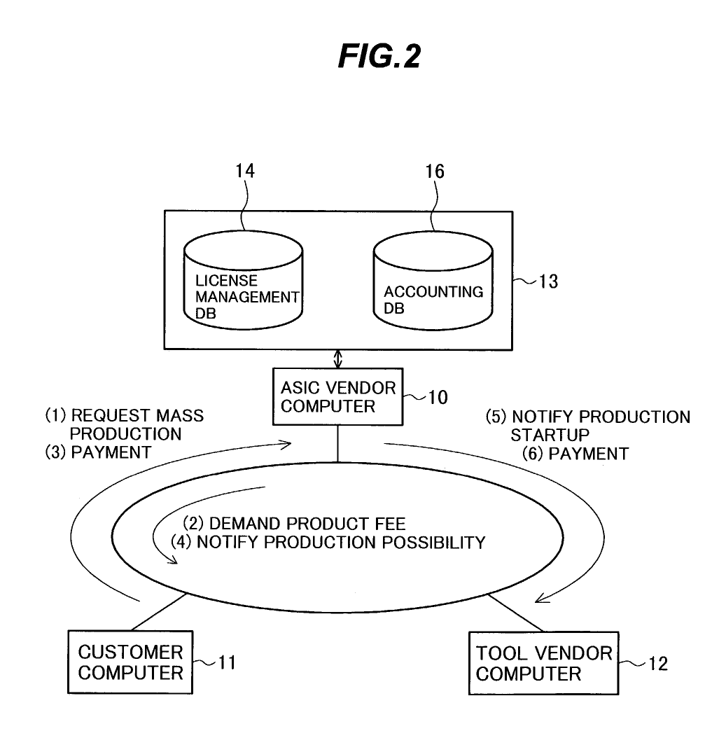

FIG. 2 is a schematic diagram showing the flow of information on the network when the mass production starts up.

When a mass production request is transmitted to the ASIC vendor computer 10 from the customer computer 11 after the integrated circuit development has succeeded, the ASIC vendor computer 10 judges if the mass production is possible with reference to information to be mentioned below and recorded in the database, and transmits the judged result to the customer computer 11. When it is judged the mass production is possible, the ASIC vendor computer 10 informs the tool vendor computer 12 that the customer will start up the mass production.

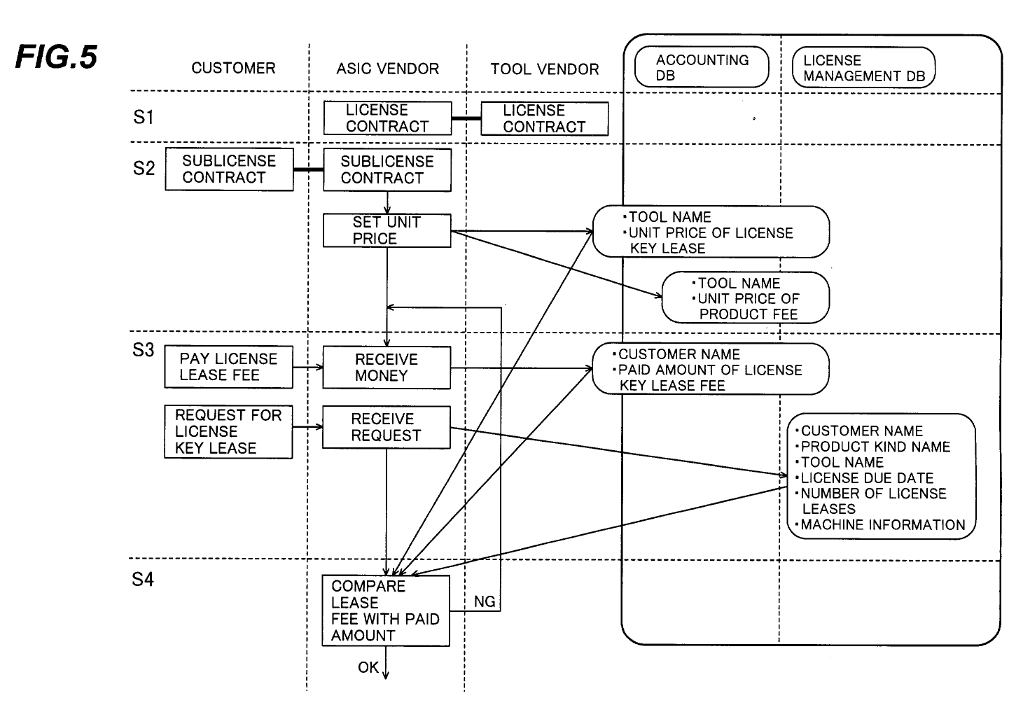

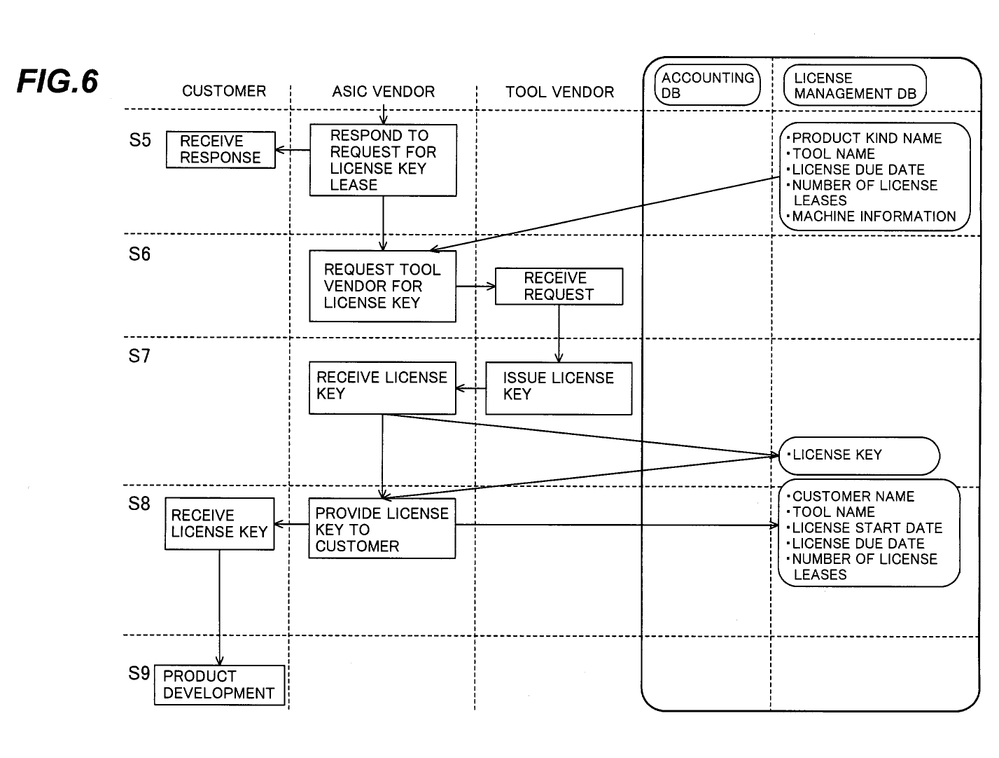

FIGS. 5 and 6 are a flowchart showing the procedure and information process of the license key lease.

(S1) A license contract is made between the ASIC vendor and the tool vendor as mentioned above.

(S2) A sublicense contract is made between the customer and the ASIC vendor as mentioned above. This sublicense contract includes unit price of license key lease (per license key and per day) and unit price of product fee (per chip) for the contract-target tool. These unit prices and the tool name are recorded in the accounting database 16. These unit prices are set at a lower price in comparison with a case where the tool vendor sets the unit prices directly for the customer.

(S3) The customer pays the license key lease fee to the ASIC vendor. In response to this payment, the customer name, paid amount of the license key lease fee, and the product kind name of development are recorded in the table 162.

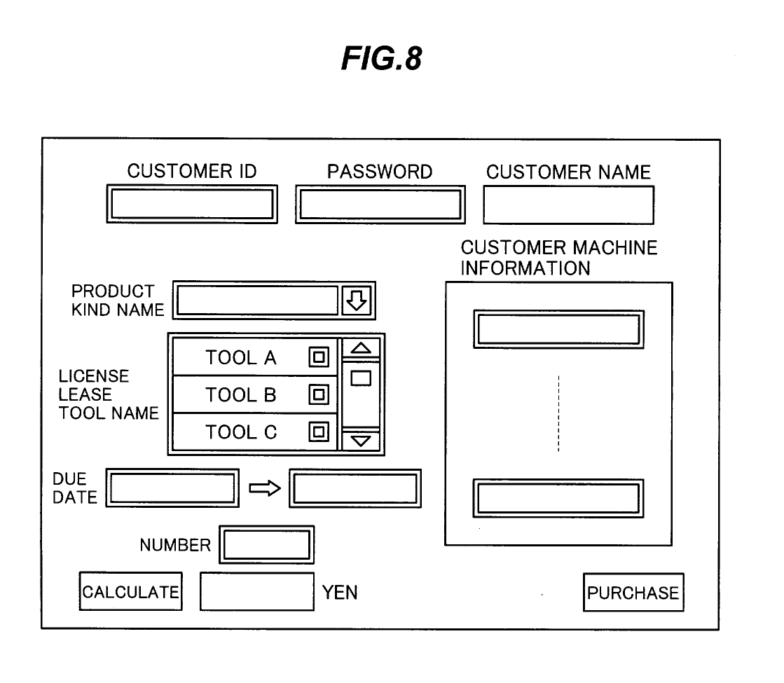

Next, the customer requests the ASIC vendor for a license key lease. Namely, referring back to FIG. 1, the customer makes access to the ASIC vendor computer 10 by manipulating the computer 11 to specify on a WWW web browser the URL of the ASIC vendor computer 10 as a WWW server. This allows an inputting form on the screen, as shown in FIG. 8, to be transmitted to the customer computer 11 from the ASIC vendor computer 10.

When the customer inputs its own ID and password, the input data is transmitted back to the ASIC vendor computer 10 for confirmation. When the input data are coincident with the registered data, information on the customer such as the customer name is transmitted to the customer computer 11 from the ASIC vendor computer 10 to be displayed on the customer computer 11. The product kind name of an integrated circuit to be developed is selected from a dropdown list of product kind names. A tool is selected by clicking a check box on the right side of a list of license-key-lease tool names. Start and due dates of license period are input. The number of license keys, whose lease the customer wants to obtain, is input. Information on the customer machine is input as a usage environment of tool.

When a calculation button on the screen is pushed, the input information on the screen is transmitted to the ASIC vendor computer 10, and the ASIC vendor computer 10 calculates its license key lease fee based on the received input information and the table 161. A file of the form of FIG. 8 including the calculate amount of the lease fee is transmitted to the customer computer 11 to update the display. The customer confirms the calculated fee, and if there is no problem, the customer clicks a purchase button on the screen that corresponds to a request for license key lease. This allows the input information on the form to be transmitted as determined information to the ASIC vendor computer 10. The ASIC vendor computer 10 records the received input information in the table 141.

For changing the input contents on the inputting form before clicking the purchase button, the customer inputs again new input data and pushes again the calculation button on the form. This allows the license key lease fee to be recalculated to update the screen display.

(S4) If the paid amount on the table 162 is more than or equal to the calculated fee, then the ASIC vendor computer 10 goes to step S5, or else, transmits information of indicating the lack of fee to the customer computer 11 so as to prompt the payment of shortage. In a case where the request for the license key lease is performed again by returning to step S3, the previously input data is read from the table 141, and the file of the inputting form on the screen of FIG. 8, to which the read data is written, is transmitted to the customer computer 11.

(S5) The ASIC vendor computer 10 informs the customer computer 11 by e-mail that a license key is expected to be transmitted to the customer. The information input in step S3 is described in this e-mail for confirmation.

(S6) The ASIC vendor computer 10 transmits the information recorded in the table 141 in step S3 to the tool vendor computer 12 to request a license key lease.

(S7) In response to this request, the tool vendor computer 12 transmits a license key to the ASIC vendor computer 10. The ASIC vendor computer 10 receives the license key and records it in the table 141.

(S8) The ASIC vendor computer 10 transmits this license key, together with the information input in the license management database 14 in step S3 for confirmation, to the customer computer 11.

The customer computer 11 downloads the tool from the tool vendor computer 12, the tool is run, and the license key is inputted to enable the tool to be available.

(S9) The customer develops the integrated circuit using this tool.

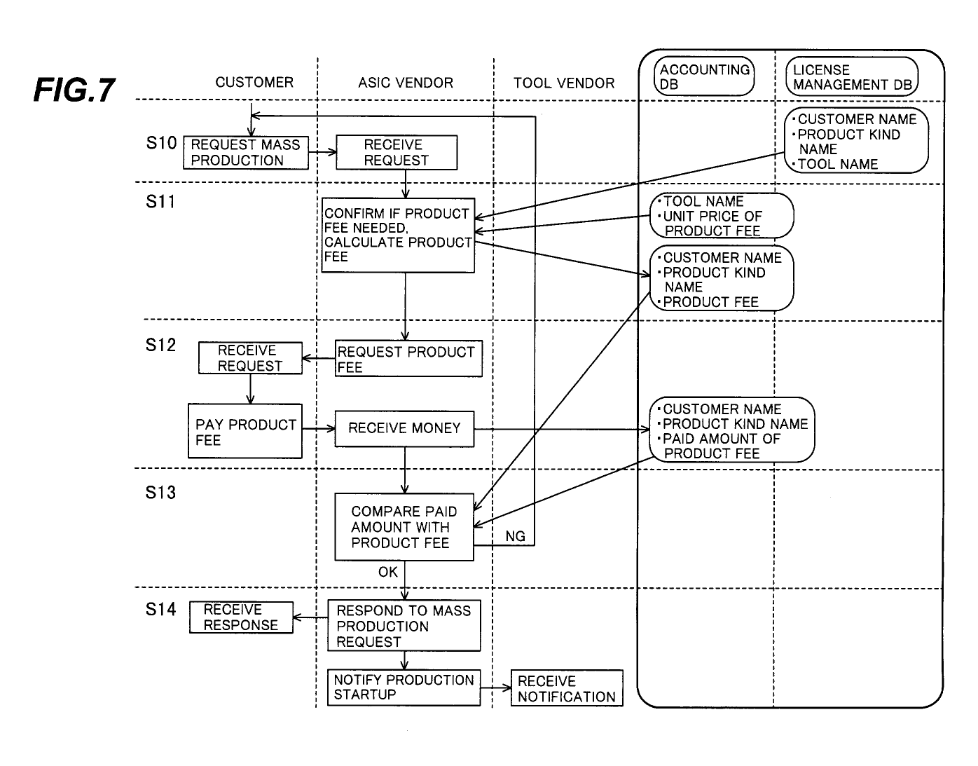

FIG. 7 is a flowchart showing the procedure and information process of the mass production startup in relation to the product fee.

(S10) When the development of the integrated circuit has been completed, the customer manipulates the customer computer 11 to specify the customer name, the product kind name, and the tool name to transmit a mass production request to the ASIC vendor computer 10. Here, when the contract is made such that the product fee is to be paid according to the number of chips, the number of products is also specified.

(S11) In response to this mass production request, the ASIC vendor computer 10 confirms that the customer name, the product kind name, and the tool name are recorded in the table 141. The ASIC vendor computer 10 searches the table 161 using the confirmed tool name as a keyword and confirms if the product fee of this tool is zero. When it is zero, data of indicating that the product fee is unnecessary is transmitted to the customer computer 11, and if not zero, the product fee is calculated and the procedure returns to step S12.

(S12) A bill on the calculated product fee is transmitted to the customer computer 11. In response to receipt of the bill, the customer pays the product fee to the ASIC vendor. This paid amount is recorded in the table 162.

(S13) In response to this recording to the table 162, the ASIC vendor computer 10 compares the paid amount with the product fee calculated in step S11. If the paid amount is more than or equal to the product fee, then the procedure goes to step S14, or else, returns to step S10.

(S14) The ASIC vendor computer 10 informs the customer computer 11 that the mass production is possible, and specifies the customer name, the product kind name, and the tool name to inform the tool vendor computer 12 of the mass production startup. Thereafter, when the mass production is performed, the product fee proportional to the number of products is paid to the tool vendor from the ASIC vendor.

Although a preferred embodiment of the present invention has been described, it is to be understood that the invention is not limited thereto and that various changes and modifications may be made without departing from the spirit and scope of the invention.

For example, the present invention may be configured such that: the customer directly pays the product fee to the tool vendor; the receipt of product fee payment is informed from the tool vendor computer 12 to the ASIC vendor computer 10; and in response to this, the ASIC vendor starts its mass production. The license key may be transmitted by post to the customer. The tool may be provided to the customer in such a manner that a recording medium with the tool recorded thereon is forwarded by post. Instead of the inputting form on the screen of FIG. 8, its input information may be transmitted by e-mail. Deferred payment may be used to pay the license key lease fee or the product fee. Part of the product fee may be paid together with the license key lease fee. In addition, the input information of FIG. 8 may be included in the sublicense contract.

What is claimed is:

1. A license management method, wherein an ASIC vendor computer, a tool vendor computer, and a customer computer are interconnected through a network, the method comprising the steps of:
(a) the customer computer transmitting first information to the ASIC vendor computer, the first information including a customer name, a development tool name, a lease condition of the development tool, and a request for a license key lease;
(b) in response to reception of the first information, the ASIC vendor computer checking whether the first information satisfies a predetermined condition of the license key lease, and transmitting to the tool vendor computer second information of requesting for the license key lease if it is determined the predetermined condition is satisfied; and
(c) in response to reception of the second information, the tool vendor computer issuing a license key for the customer.

2. The license management method according to claim 1, wherein the lease condition in the step (a) includes a period of the license key lease and number of the development tools.

3. The license management method according to claim 1,
wherein the predetermined condition in the step (b) is part of a sublicense contract completed between the ASIC vendor and the customer in advance,
wherein a license contract to permit the sublicense contract has been completed between the tool vendor and the ASIC vendor before the sublicense contract is completed.

4. The license management method according to claim 3,
wherein a storage device storing an accounting database is coupled to the ASIC vendor computer, and paid amount information including a paid amount of each customer is recorded in the accounting database,
wherein in the step (b), the ASIC vendor computer calculates a license key lease fee based on the first information received from the customer computer,
wherein the predetermined condition includes that the paid amount of the customer is more than or equal to the license key lease fee.

5. The license management method according to claim 3,
wherein a storage device storing a license management database is coupled to the ASIC vendor computer,
wherein in the step (b), the ASIC vendor computer records at least part of the received first information into the license management database, and the second information includes at least part of a record in the license management database.

6. The license management method according to claim 3, further comprising the step of:
(d) in response to third information on a request for an integrated circuit mass production from the customer, the ASIC vendor computer transmitting fourth information on startup of the integrated circuit mass production to the tool vendor computer.

7. The license management method according to claim 6, wherein, in the step (d), the customer computer transmits the third information to the ASIC vendor computer.

8. The license management method according to claim 7,
wherein a storage device storing an accounting database is coupled to the ASIC vendor computer, paid amount information including a paid amount of each customer and a unit price of product fee are recorded in the accounting database,
wherein in the step (d), the ASIC vendor computer:
calculates a product fee based on the third information and the unit price of product fee;
judges whether the paid amount of the customer is more than or equal to the product fee before the transmission of the fourth information to the tool vendor computer; and
performs the transmission of the fourth information if the judgment result is affirmative, or else, transmits to the customer computer fifth information indicating that the integrated circuit mass production is impossible.

9. A computer program product comprising a computer program for causing an ASIC vendor computer to perform a license management, the computer program causes the ASIC vendor computer to perform the steps of:
(a) in response to receipt of first information of a customer name, a development tool name, a lease condition of development tool, and a request for a license key lease from a customer computer, checking whether a predetermined condition of the license key lease is satisfied; and
(b) if it is determined that the predetermined condition is satisfied, transmitting second information of the request for the license key lease of the development tool to a tool vendor computer.

10. The computer program product according to claim 9,
wherein the computer program causes the ASIC vendor computer in the step (a) to calculate a license key lease fee based on both the first information and an accounting database recording paid amount information including a paid amount of each customer,
wherein the predetermined condition is that the paid amount of the customer is more than or equal to the license key lease fee.

11. The computer program product according to claim 10,
wherein the computer program causes the ASIC vendor computer in the step (a) to record at least part of the received first information into a license management database,
wherein in the step (b), the second information includes at least part of a record in the license management database.

12. The computer program product according to claim 11, wherein the computer program causes the ASIC vendor computer to further perform the step of:
(c) in response to third information on a request for an integrated circuit mass production from the customer, transmitting fourth information on startup of the integrated circuit mass production to the tool vendor computer.

13. The computer program product according to claim 12,
wherein a unit price of product fee is further included in the accounting database,
wherein the computer program causes the ASIC vendor computer in the step (c) to:
calculate a product fee based on the third information and the unit price of product fee;
judge whether the paid amount of the customer is more than or equal to the product fee before the transmission of the fourth information to the tool vendor computer; and
perform the transmission of the fourth information if the judgment result is affirmative, or else, transmit to the customer computer fifth information indicating that the integrated circuit mass production is impossible.

14. A license management apparatus comprising:
an ASIC vendor computer;
a storage device coupled to the ASIC vendor computer; and
a computer program stored on the storage device for causing the ASIC vendor computer to perform a license management,
wherein the computer program causes the ASIC vendor computer to perform the steps of:
(a) in response to receipt of first information of a customer name, a development tool name, a lease condition of development tool, and a request for a license key lease from a customer computer, checking whether a predetermined condition of the license key lease is satisfied; and
(b) if it is determined that the predetermined condition is satisfied, transmitting second information of the request for the license key lease of the development tool to a tool vendor computer.

15. The license management apparatus according to claim 14,
wherein the computer program causes the ASIC vendor computer in the step (a) to calculate a license key lease fee based on both the first information and an accounting database recording paid amount information including a paid amount of each customer,
wherein the predetermined condition is that the paid amount of the customer is more than or equal to the license key lease fee.

16. The license management apparatus according to claim 15,
wherein the computer program causes the ASIC vendor computer in the step (a) to record at least part of the received first information into a license management database,
wherein in the step (b), the second information includes at least part of a record in the license management database.

17. The license management apparatus according to claim 16, wherein the computer program causes the ASIC vendor computer to further perform the step of:
(c) in response to third information on a request for an integrated circuit mass production from the customer, transmitting fourth information on startup of the integrated circuit mass production to the tool vendor computer.

18. The license management apparatus according to claim 17,
wherein a unit price of product fee is further included in the accounting database,
wherein the computer program causes the ASIC vendor computer in the step (c) to:
calculate a product fee based on the third information and the unit price of product fee;
judge whether the paid amount of the customer is more than or equal to the product fee before the transmission of the fourth information to the tool vendor computer; and
perform the transmission of the fourth information if the judgment result is affirmative, or else, transmit to the customer computer fifth information indicating that the integrated circuit mass production is impossible.
